(19) United States
(12) Patent Application Publication
(10) Pub. No.: US 2019/0228890 A1
(43) Pub. Date: Jul. 25, 2019

(54) METHOD FOR PRODUCTION OF A COMPONENT HAVING SOFT-MAGNETIC PROPERTIES

(71) Applicant: Miba Sinter Austria GmbH, Laakirchen (AT)

(72) Inventors: Magdalena DLAPKA, Voecklabruck (AT); Robert HELLEIN, Gmunden (AT); Christian SANDNER, Gmunden (AT); Herbert DANNINGER, Wien (AT); Christian GIERL-MAYER, Wien (AT); Kevin OUDA, Rohrbach (AT)

(73) Assignee: Miba Sinter Austria GmbH, Laakirchen (AT)

(21) Appl. No.: 16/208,763

(22) Filed: Dec. 4, 2018

(30) Foreign Application Priority Data
Jan. 24, 2018 (AT) A 50061/2018

(51) Int. Cl. H01F 1/147; H01F 1/22

(52) U.S. Cl. CPC H01F 1/147; H02K 1/02; H01F 1/22

(57) ABSTRACT

The invention relates to a method for the production of a component having soft-magnetic properties, from an SMC powder, comprising the steps of filling the SMC powder into a powder press (1), pressing the SMC powder to form the component, removing the component from the powder press (1), if necessary reworking the component. Pressing the SMC powder to form the component is carried out at a temperature between 300° C. and 650° C.

The invention relates to a method for production of a component having soft-magnetic properties, from an SMC powder, comprising the steps: filling the SMC powder into a powder press, pressing the SMC powder to form the component, removing the component from the powder press, if necessary reworking the component.

SMC powders (Soft Magnetic Composites) have been known for a long time. These are powders composed of soft-magnetic material, the surface of which is covered with an electrically insulating layer. These powders are consolidated to form soft-magnetic components, by means of pressing. Due to the increasing importance of electric mobility, SMC powders have come to be used in the production of electric motor components in the meantime, since in this way, in contrast to conventional laminated sheet metal, a three-dimensional alternating magnetic flow is possible at low losses. As a result, it becomes possible to build vehicles that are lighter at the same power or that make greater power available than was possible until now, at the same weight of the drive.

Since great densities are required in the case of SMC components, high pressing pressures are required for pressing the SMC powders. The tensions and displacements introduced into the material during the pressing process as a result have a negative effect on the magnetic properties of the component, for example due to hysteresis losses. Therefore a heat treatment is usually carried out after pressing, as described in paragraph [0016] of EP 1 620 932 B1, for example. By means of the heat treatment, the tensions introduced during pressing are relaxed to the greatest possible extent, and thereby hysteresis losses can be reduced.

The present invention is based on the task of indicating a simpler method for the production of SMC components.

The task of the invention is accomplished, in the case of the method stated initially, in that pressing the SMC powder to form a component is carried out at a temperature between 300° C. and 650° C.

With this method, the result is achieved that by means of the reduced yield strength of the SMC powder at these high temperatures, lower tensions are introduced into the material. This makes it possible that an additional heat treatment can be eliminated entirely or that it can be carried out at far lower temperatures and/or with shorter holding times. In addition, a higher density in the SMC component can be achieved by means of the better formability of the SMC powder at the pressing temperature. This in turn improves density-dependent magnetic properties such as saturation, residual magnetism, and permeability of the soft-magnetic component that is produced.

According to one embodiment variant of the method, it can be provided that the temperature is selected from a range of 400° C. to 650° C. In this way, the aforementioned effects can be further improved.

According to another embodiment variant of the method, an optional heat treatment of the component immediately after the component is removed from the powder press can take place. In this regard, the component can be further relaxed, if needed, although this is not absolutely necessary according to the invention, as has already been explained above.

It is also advantageous if, according to another method variant, an SMC powder that has an average particle size of 10 μm to 300 μm is used, since in this way, thorough warming of the powder particles and, as a result, the above effects can be further improved.

To improve filling of the powder press, it can furthermore be provided that the SMC powder is used in agglomerated form, at least in part.

For further improvement of this effect, the agglomerates can have a maximal size between 60 μm and 600 μm.

However, it can also be provided that the SMC powder is pre-heated before it is filled into the powder press, and thereby the cycle time of production of the soft-magnetic components can be reduced. In this way, it is also possible to reduce temperature variations in the press that are caused by the introduction of cold powder, and thereby the properties of the soft-magnetic components can be further improved.

Pressing the SMC powder to produce the component can be carried out under inert gas, according to a further method variant, so as to further improve the soft-magnetic properties of the SMC component by means of the exclusion of oxygen, carbon, etc.

For a better understanding of the invention, it will now be explained in greater detail using the following figures.

These show, in a greatly simplified, schematic representation, in each instance:

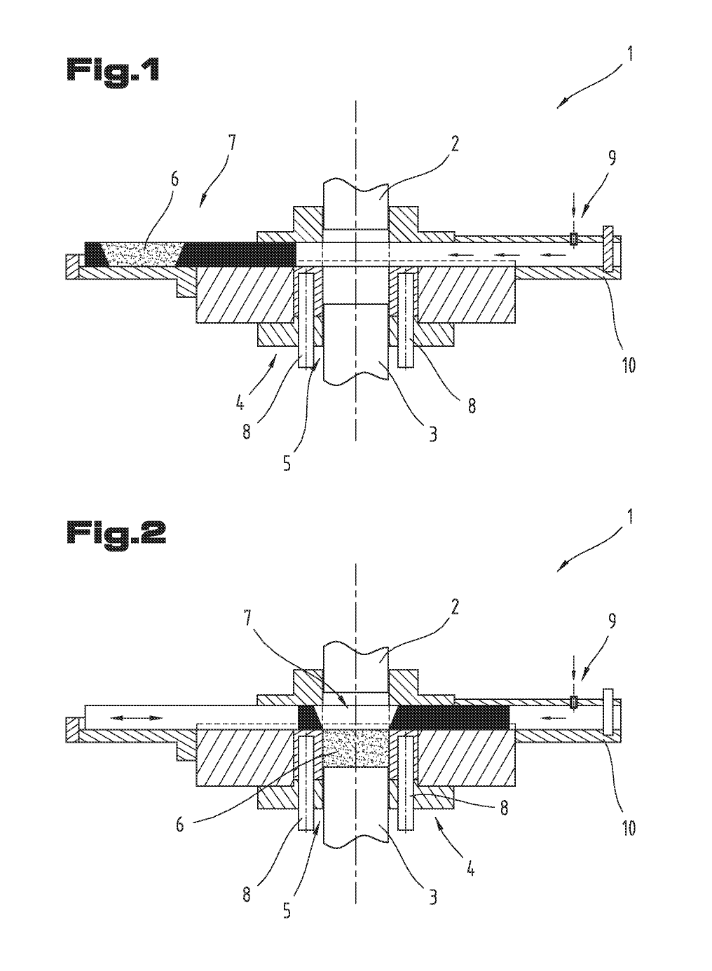

FIG. 1 a detail of a powder press in a first position;

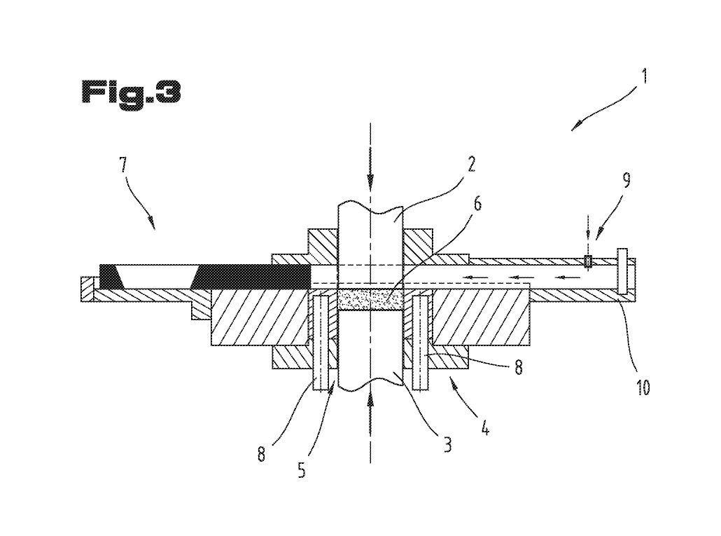

FIG. 2 a detail of the powder press according to FIG. 1 in a second position;

FIG. 3 a detail of the powder press according to FIG. 1 in a third position.

As an introduction, it should be stated that in the different embodiment variants described, the same parts are provided with the same reference symbols or the same component designations, wherein the disclosures contained in the description as a whole can be applied analogously to the same parts having the same reference symbols or the same component designations. Also, the position information selected in the description, such as at the top, at the bottom, on the side, etc., for example, refer to the specific figure being described and shown, and this information should be transferred analogously to the new position in the event of a change in position.

In FIGS. 1 to 3, a detail of a powder press 1 is shown in different method positions. The powder press 1 comprises an upper punch 2, a lower punch 3, a (divided) matrix 4, which has a recess 5 for holding and pressing a powder 6. The upper punch and the lower punch 2, 3 also plunge into this recess 5 during pressing of the powder 6. This entire apparatus is also held in a frame, but this frame is not shown.

Since such a structure of a powder press 1 is known as such, reference is made to the relevant state of the art with regard to further details.

The powder press 1 is used to carry out a method for the production of a component having soft-magnetic properties. For this purpose, an SMC powder (Soft Magnetic Composite) is used as the powder 6.

The SMC powder has particles that comprise a core that is surrounded by an insulation layer or multiple insulation layers, or consist of the core and the at least one insulation layer. If necessary, a binder layer, with which the individual particles can be connected with one another, can also be applied to the insulation layer, on the outside.

The core can have a pure iron powder or consist of such a powder. However, other magnetizable materials or alloys can also be used as a core, such as, for example, iron alloys with Si and/or Ni and/or P.

This core is completely surrounded by the at least one insulation layer. The at least one insulation layer can be of an organic nature, for example a silicone varnish, or of a metal-organic nature or inorganic nature, for example an oxide layer, a silicate layer, a phosphate layer. In the case of multiple insulation layers, these can also consist of different materials, for example selected from among the aforementioned materials.

The insulation layer or insulation layers can have an average layer thickness (arithmetical average of at least ten individual values) between 0.01 μm and 800 μm.

The binder layer that might be present can be a polymer layer, for example PTFE, wax, etc.

Fundamentally, this structure of SMC powders is also known from the state of the art, so that no further explanations in this regard are required.

Preferably, however, according to one embodiment variant, an SMC powder is used that has an average particle size of 10 μm to 300 μm, in particular between 40 μm to 260 μm. Also, powders having a particle size of more than 300 μm can be used. Furthermore, an at least partially agglomerated SMC powder can also be used. The agglomerate size can amount to between 60 μm and 600 μm.

The SMC powder, which can be pre-mixed, if necessary, is filled into the recess 5 of the matrix 4, which, together with the lower punch 3, forms a mold cavity of the powder press 1, for pressing. For this purpose, the SMC powder can simply be filled into the open mold cavity from above.

In the preferred embodiment variant of the method, however, a filling shoe 7 is used, which holds the amount of SMC powder that is required for a pressing process. The filling shoe 7 can furthermore be configured to narrow (conically), so that the SMC powder slides into the mold cavity more easily.

The filling shoe 7 preferably stands at the side next to the mold cavity in the filling position for the SMC, and, after being filled with the SMC powder, can be brought into a position above the mold cavity by means of a linear movement and/or a rotational movement, so that the SMC powder slides into the mold cavity due to gravity. This position is shown in FIG. 2.

Afterward, the filling shoe 7 is brought back into its starting position, and the SMC powder is pressed uni-axially or co-axially by means of an upward movement of the lower punch 3 and/or a downward movement of the upper punch 3, as shown in FIG. 3.

The pressing pressure during pressing can amount, in particular, to between 200 MPa and 1500 MPa.

By means of pressing of the SMC powder, the component is produced from it, which component is subsequently removed from the powder press 1, in particular ejected using the lower punch 3.

If necessary, the finished component can also be reworked, for example calibrated or post-compacted. If necessary, subsequent heat treatment can also take place, although this is not absolutely necessary, since the component is already subjected to heat treatment in the powder press 1. Within the scope of the method, it is provided, in this regard, that pressing the SMC powder to produce the component is carried out at a temperature between 300° C. and 650° C., in particular at a temperature between 400° C. and 650° C.

For this purpose, the powder press 1, in particular the matrix 4, has at least one heating device 8.

The heating device 8 can have at least one, preferably multiple heating elements, in particular rod-shaped heating elements, which are inserted into corresponding recesses in the matrix 4, as can be seen in the figures.

Heating itself can take place electrically, for example, by means of resistor heating elements. However, other types of heating can also be used, such as heating with liquid media.

The mold cavity, and thereby also the SMC powder can be pre-heated or heated to the desired temperature by way of the heating device and the good heat conductivity of the preferably metallic material of the matrix. Preferably, the matrix is slightly hotter than the method temperature indicated above as being 300° C. to 650° C., in particular hotter by 10° C. to 40° C.

Preferably, heat treatment of the component therefore takes place directly in the powder press 1. However, it is also possible that in addition, subsequent heat treatment (as known from the state of the art) is carried out. However, this takes place at a temperature that is clearly lower than is usual in the case of heat treatments that are currently carried out and/or with a holding time at the temperature that is less than is currently usual in the state of the art.

It is furthermore possible that the SMC powder is pre-heated before it is filled into the powder press. For example, it can be pre-heated to a temperature between 50° C. and 200° C.

According to one embodiment variant, it is preferably provided that pressing the SMC powder to produce the component is carried out under inert gas. For this purpose, the powder press 1 can have an inert gas connector 9, for example a connector for nitrogen or argon. Preferably, this inert gas connector 9 is disposed in the course of a filling shoe guide 10.

However, feed of the inert gas can also take place by means of a perforation in the upper punch 2. In this way, the inert gas can also be better used to introduce (blow in) the SMC powder into the mold cavity.

The exemplary embodiments describe possible embodiment variants, wherein combinations of the individual embodiment variants with one another are also possible.

For the sake of good order, it should be pointed out, in conclusion, that for a better understanding of the structure of the powder press 1, the latter is not necessarily shown to scale.

### REFERENCE SYMBOL LIST

1 powder press

2 upper punch

3 lower punch

4 matrix

5 recess

6 sintering powder

7 filling shoe

8 heating device

9 inert gas connector

10 filling shoe guide

1. A method for the production of a component having soft-magnetic properties, from an SMC powder, comprising the steps:
filling the SMC powder into a powder press (1),
pressing the SMC powder to form the component,
removing the component from the powder press (1),
if necessary, reworking the component,
wherein
pressing the SMC powder to form the component is carried out at a temperature between 300° C. and 650° C.

2. The method according to claim 1, wherein pressing is carried out at a temperature selected from a range of 400° C. to 650° C.

3. The method according to claim 1, wherein an additional heat treatment of the component is carried out immediately after removing the component from the powder press (1).

4. The method according to claim 1, wherein an SMC powder is used that has an average particle size of 10 μm to 300 μm.

5. The method according to claim 4, wherein the SMC powder is used in agglomerated form, at least in part.

6. The method according to claim 5, wherein the agglomerates have a size between 60 μm and 600 μm.

7. The method according to claim 1, wherein the SMC powder is pre-heated before it is filled into the powder press (1).

8. The method according to claim 1, wherein pressing the SMC powder to form the component is carried out under inert gas.
